(19) United States
(12) Patent Application Publication
(10) Pub. No.: US 2002/0140271 A1
(43) Pub. Date: Oct. 3, 2002

(54) Transparent automobile headrest

(76) Inventor: James Colvin Owen, Lexington, KY (US)

Correspondence Address: JAMES COLVIN OWEN M.D, 330 ROMANY RD, LEXINGTON, KY, 40502, US

(21) Appl. No.: 09/820,608

(22) Filed: Mar. 30, 2001

(51) Int. Cl. A47C 1/10; A47C 7/36; A61G 15/00; B60R 22/28

(52) U.S. Cl. 297/391

(57) ABSTRACT

A vehicle headrest that is transparent. The head restraint is made of firm mildly flexible but clear material in the form of a cut out plate extending from the upper seat back and serving the function of limiting the cervical hyperextension without injuring the skull. An embodiment of this would use the plate as a frame for a clear elastic water, gel and or air filled balloon-like headrest. Another embodiment is a self supporting transparent elastic balloon with water, clear jell and or air fill that surrounds the head upon impact.

### REFERENCES CITED

U.S. Patent Documents:

Novenber.,2000 Takei, et al. 297/220

May2000 Russell 297/410

October.,1999 Hogan, et al. 297/397

October. 1992 Lacy 297/397

September., 1987 Russo, et al. 297/391

February.,26,1980 Brunig, et al. 297/391

Other references:

(1) Chapline J F, Ferguson S A, Lillis R P, Lund A K, Williams A F. Neck pain and head restraint position relative to the driver's head in rear-end collisions. Accid. Anal. Prev. 2000 March;32(2):287-97.

(2) Viano D C, Gargan M F. Headrest position during normal driving: implication to neck injury risk in rear crashes. Accid. Anal. Prev. 1996Nov;28(6):665-74.

(3) Lubin S, Schmer J. Are automobile head restraints used effectively ? Can.Fam.Physician 1993 July;39: 1584-88.

### BACKGROUND OF THE INVENTION

It has been estimated that 45% of females and 28% of males involved in a two car rear end type crash complain of neck pain.(1) Of these many go on to have prolonged and severe impairment. In a study of a random 1915 vehicles only 10% had their headrest adjusted to the most favorable position to avoid neck extension during a rear end crash. Hyge sled tests using various positions with a Hybrid III dummy have shown a relative injury risk of 3.4 in rear end crashes. This compares with 1.0 if the most favorable headrest position is being used. This translates to at least a 28.3% reduction in whiplash injury.(2) Two factors allow this problem to occur. Headrests have been made progressively more adjustable.(Takei,Russell,Lacy,Russo) Drivers and passengers have little education as to the necessity for rear restraint and thus do not properly attend to headrest adjustment.(3) The fact that 73% of cars were found to have the headrest in its lowest position(1) perhaps indicates that something other than random uninformed choice is in operation. It is conjectured that most drivers leave the headrest down in order to avoid obscuring their over the shoulder vision. This being especially true of the rear compartment headrest. Were those headrests transparent and fixed in best functioning position for any passenger significant morbidity could be automatically avoided.

### BRIEF DESCRIPTION OF THE INVENTION

An Automobile or Truck transparent headrest that allows the driver or passenger an over the shoulder view but safely, appropriately and comfortably restrains the head from excessive posterior movement. According to the invention the headrest would consist of transparent material ballooned in the shape of currently employed headrests and having all the advantages of modern headrests. It would be attached by means of a transparent semi-rigid vertical plate designed to accommodate the specific vehicle's seat requirements or it may be self-supporting. Connection of the ballooned transparent headrest to the plate would be by a slit-like channel in the balloon or Velcro designed in such a manner to as much as possible not impede vision. The plate would offer necessary structural support if the balloon aspect failed. The plate consists of flat firm transparent plastic resilient enough to perform the essential function of a headrest by bending slightly at the point of attachment to the seat. This minimal flexibility would have the effect of reducing cervical hyperextension. This arrangement would offer less comfort when struck but greater transparency. Another embodiment of the invention would be a transparent elastic balloon in the shape of a headrest that is self-supporting and water, clear jell or air filled. This latter embodiment may be large enough to envelope the head when struck offering protection from lateral impingement as well as posterior movement.

### BRIEF DESCRIPTION OF THE DRAWINGS

The invention will be better understood after a reading of the following description of the preferred embodiment.

FIG. 1 is an anterior view of the clear cut out plate-like restraint. It is 1-2 cm. wide and made to bend slightly with impact. Shape would be as shown but could be contoured or tilted for maximum efficiency and aesthetic effect.

FIG. 2 is a lateral view of the seat top with the clear plate in position. Attachment may be by insertion into seat top by slit-like channel or by rods built into the body of the plate. This view shows the clear elastic balloon filled with water clear jell and or air attached to the plate.

FIG. 3 is a axial view of the plate with clear plastic bars for attachment with the clear elastic balloon attached. The passengers head is shown in the position during impact The balloon expands to essentially cover the posterior and posterior-lateral head and neck.

FIG. 4 is a lateral view showing the removable elastic transparent balloon option. Attachment is by a slit-like channel in the posterior of the balloon. At time of impact the lateral balloon expands forward covering the ears and lateral face of the passenger.

FIG. 5 shows the design of the balloon to be in the form of a clear surround with open areas in the center supported by the clear plastic cut out plate. All structures are as transparent as possible.

FIG. 6 shows the elastic restraint balloon without the firm plate. This structure is filled with water, clear jell and or air large enough to protect the head from side impact when the head has moved posterior and is embedded in the balloon. This embodiment would require a larger impact support area as shown. Attachment would be sewn in or by belt mechanism.

### DETAILED DESCRIPTION

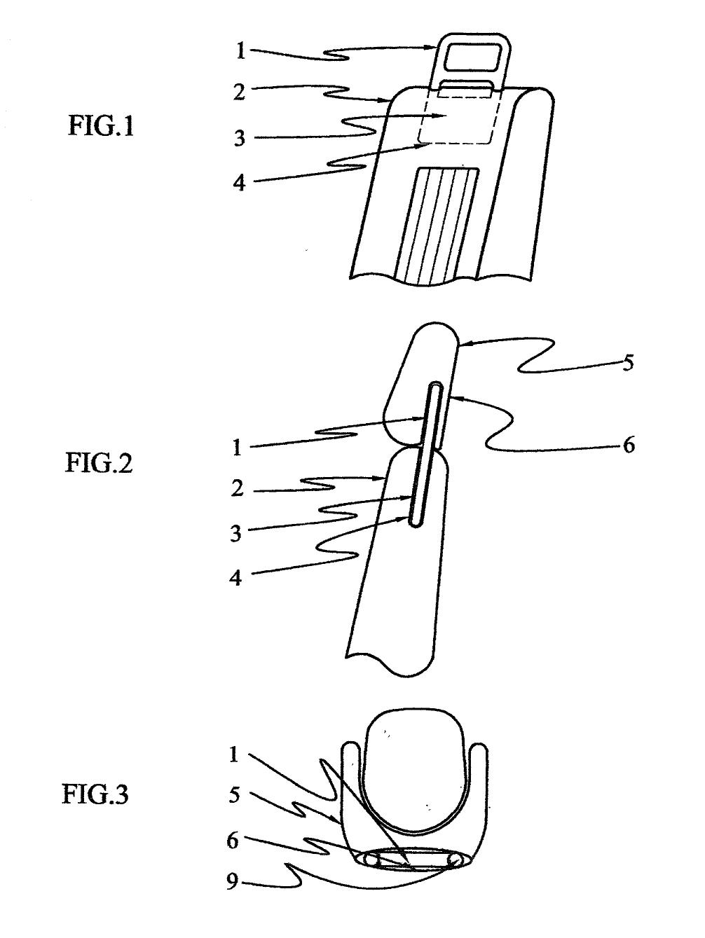

As shown in FIG. 1. the clear resilient cut out plate 1 is positioned on top of the vehicle seat 2 such that a person's head impacting the restraint would proceed posterior for 3-4 cm. Being slowed progressively by the natural resilience of the restraint material. This would at the same time reduce the impact effect on the skull and stop the extreme hyperextension of the cervical spine. This bending process would tend to automatically contour to the curvature of the cervical spine thus reducing the need for a shaped pillow. (Hogan) The plate would be extended into seat back 3 and secured by the slit like channel 4. The entire mechanism may be removable.

As shown in FIG. 2. the plate 1 is approximately 1-2 cm. thick and is attached to the seat in a secure manner extending into the seat sufficient depth to allow complete stability of the lower aspect 3.

Attachment by bendable metal rods or springs built into the plate and connected to the seat in the manner usual for the specific seat manufacturer would be another embodiment of the invention. Also seen in this view is the detachable clear elastic balloon filled with water, clear jell and or air 5. It is attached by means of a channel like slit in the posterior aspect of the balloon 6. This serves as both an added safety mechanism in reducing impact as well as a comfort feature for passengers.

As shown in FIG. 3. the plate 1 with molded in place metal rods 9 that are themselves appropriately bendable and attached with the usual make and model seat attachment for a given manufacturer.

Shown also is the head position at the time of impact and the added safety of the expanded balloon.

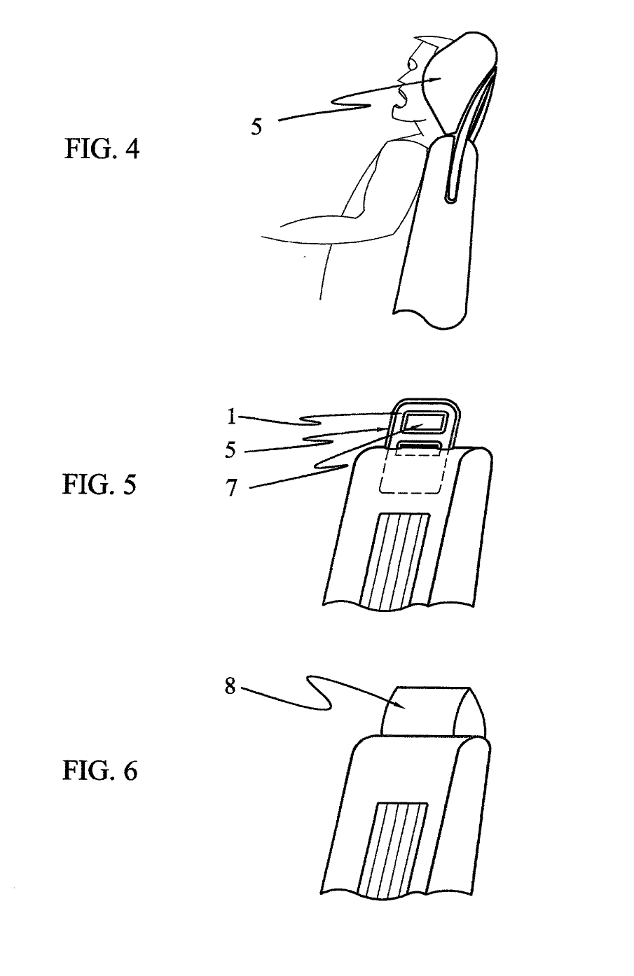

As is shown in FIG. 4 the clear headrest shaped balloon that fits over the restraint plate and is expanded 5 to give protection to the lateral head.

The shape of the balloon would be determined by various manufacturers to be as aesthetically pleasing as possible.

As is shown in FIG. 5 the balloon 5 may also be filled with water clear jell and/or air but more closely surrounding the firm plate 1 with open areas in the design 7.

As is shown in FIG. 6 the clear elastic balloon 8 that is water gel and/or air filled may also be self supporting large enough and appropriately shaped to allow head restraint without the necessity of the plate.

What is claimed is:

1) A transparent semi-rigid vehicle head restraint that safely limits cervical hyperextension.

2) A method of attaching this restraining mechanism to any vehicle.

3) A removable headrest-shaped transparent elastic balloon that is water, gel and or air filled attached to said restraint.

4) Said transparent elastic water, gel and or air filled balloon material made to closely surround the semi-rigid restraint.

5) Said transparent headrest-shaped elastic balloon self supporting and filled with water, clear jell and or air that acts to surround the head in a pillow like manner upon impact.
